(19) United States
(12) Patent Application Publication
(10) Pub. No.: US 2014/0139657 A1
(43) Pub. Date: May 22, 2014

(54) DISPLAY BRACKET AND METHOD FOR ADJUSTING DISPLAY BRACKET

(71) Applicant: Hon Hai Precision Industry Co., Ltd., New Taipei (TW)

(72) Inventors: HSIAO-PING CHIU, New Taipei (TW); HSUEH-TSEN TSAI, New Taipei (TW); CHIA-NAI TU, New Taipei (TW)

(73) Assignee: HON HAI PRECISION INDUSTRY CO., LTD., New Taipei (TW)

(21) Appl. No.: 14/053,596

(22) Filed: Oct. 14, 2013

(30) Foreign Application Priority Data
Nov. 22, 2012 (TW) 101143655

(51) Int. Cl. H04N 7/18

(52) U.S. Cl. CPC H04N 7/18
USPC 348/78

(57) ABSTRACT

A display bracket is electronically and physically connected to a display. The display is installed with a camera and an infrared sensor. First, a user is prompted to look straight ahead. The camera captures a first image of eyeballs of the user. Then the user is prompted to look at the camera, the camera captures a second image of the eyeballs. An initial angle between the display and the display bracket is detected. When the user is looking at the display, the camera captures a third image of the eyeballs. The angle between the display and the display bracket to be adjusted is calculated according to the first image, the second image, the third image and the initial angle between the display and the display bracket.

### BACKGROUND

1. Technical Field

Embodiments of the present disclosure relate to display management technology, and more particularly to a display bracket and a method for adjusting the display bracket.

2. Description of related art

When a user views data displayed on a display, if an angle between the display and a display bracket is not appropriate, the user may suffer from eyestrain. Therefore the user has to adjust the angle manually. Because the user may view the display from different viewpoints, the user may have to adjust the angle frequently.

### BRIEF DESCRIPTION OF THE DRAWINGS

FIG. 1 is a block diagram of one embodiment of a display bracket including an adjusting system.

FIG. 2 is a block diagram of one embodiment of function modules of the adjusting system in FIG. 1.

FIG. 3 is a flowchart of one embodiment of a method for adjusting the display bracket.

FIG. 4 is a schematic diagram illustrating one embodiment of the display bracket before being adjusted.

FIG. 5 is a schematic diagram illustrating one embodiment of the display bracket after being adjusted.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

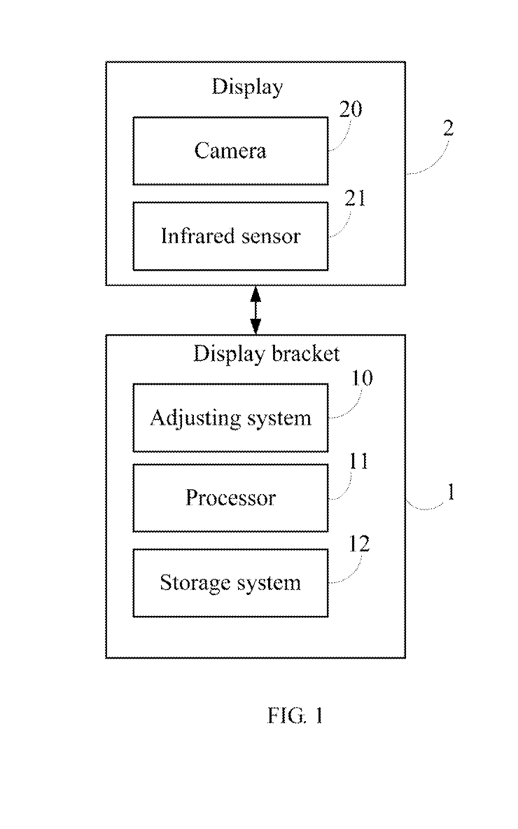

FIG. 1 is a block diagram of one embodiment of a display bracket 1. The display bracket 1 includes an adjusting system 10, a processor 11, and a storage system 12. The display bracket 1 connects to a display 2. In one embodiment, the display 2 may be a display of a desktop computer, a display of a notebook, or a display of a laptop computer, for example. The display 2 is installed with a camera 20 and an infrared sensor 21. In one embodiment, the camera 20 is installed in a top edge of the display 2. The infrared sensor 21 is installed in a lower edge of the display 2. The camera 20 captures pictures of eyeballs of a user and sends the pictures to the processor 11 of the display bracket 1. The infrared sensor 21 senses the user and measures a distance between the user and the display 2. In order for the infrared sensor 21 to sense the user, the lower edge of the display 2 is not higher than a sitting height of the user.

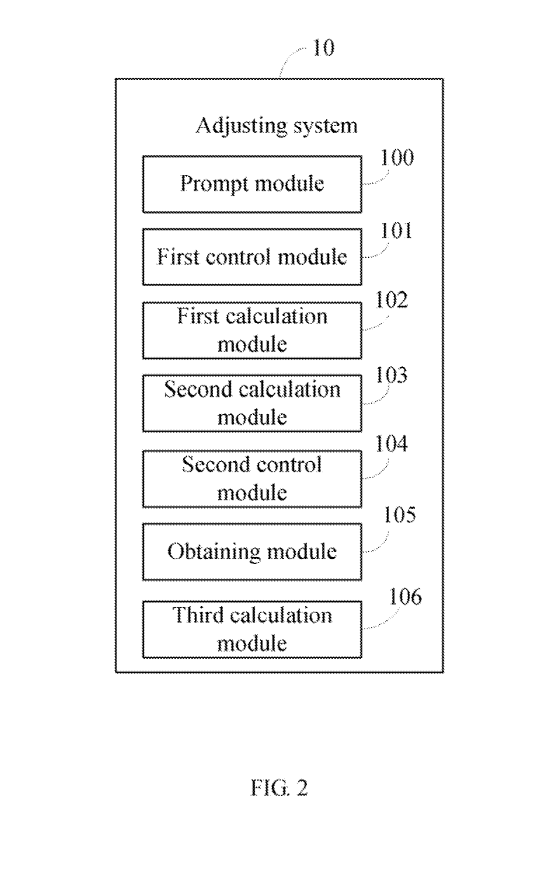

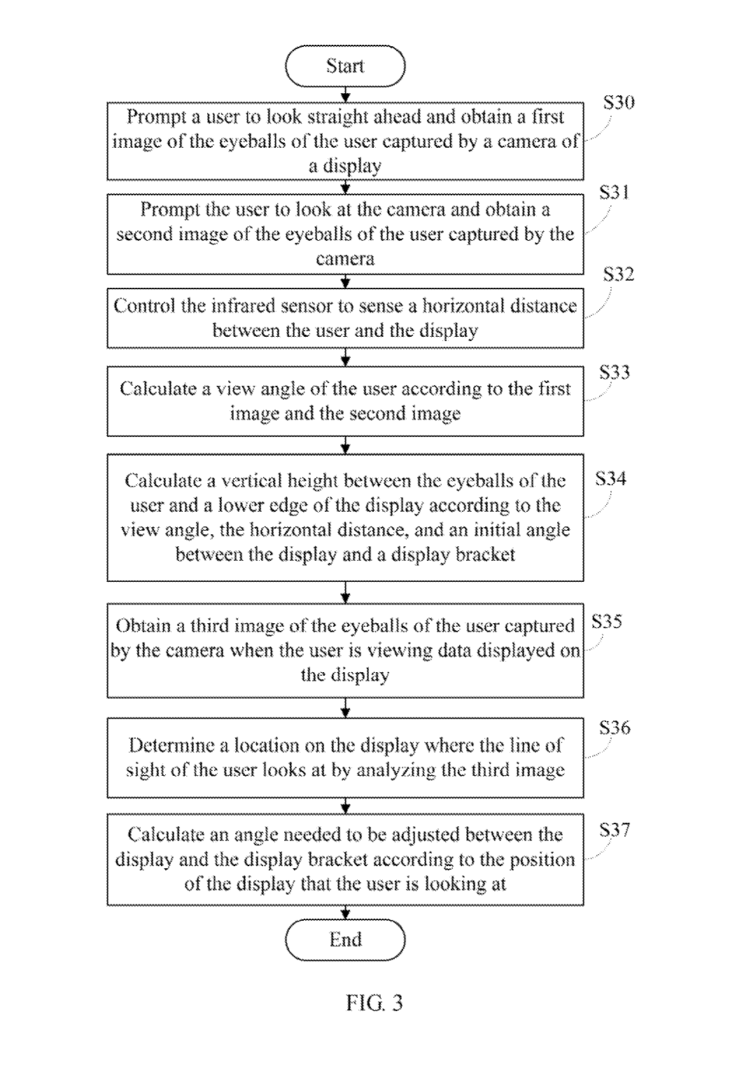

As shown in FIG. 2, the adjusting system 10 includes a plurality of function modules, such as a prompt module 100, a first control module 101, a first calculation module 102, a second calculation module 103, a second control module 104, an obtaining module 105, and a third calculation module 106. The modules 100-106 include computerized code in the form of one or more programs that are stored in the storage system 12. The computerized code includes instructions that are executed by the processor 11, to provide functions of the adjusting system 10. Detailed functions of the modules 100-106 are given in reference to FIG. 3.

FIG. 3 is a flowchart of one embodiment of a method for adjusting the display bracket. Depending on the embodiment, additional steps may be added, others removed, and the ordering of the steps may be changed.

In step S30, the prompt module 100 prompts a user to look straight ahead and obtains a first image of eyeballs of the user captured by the camera 20.

In step S31, the prompt module 100 prompts the user to look at the camera 20 and obtains a second image of the eyeballs of the user captured by the camera 20.

In step S32, the first control module 101 controls the infrared sensor 21 to sense a horizontal distance between the user and the display 2 by using infrared rays. In one embodiment, the horizontal distance is a horizontal distance between the user and the lower edge of the display 2.

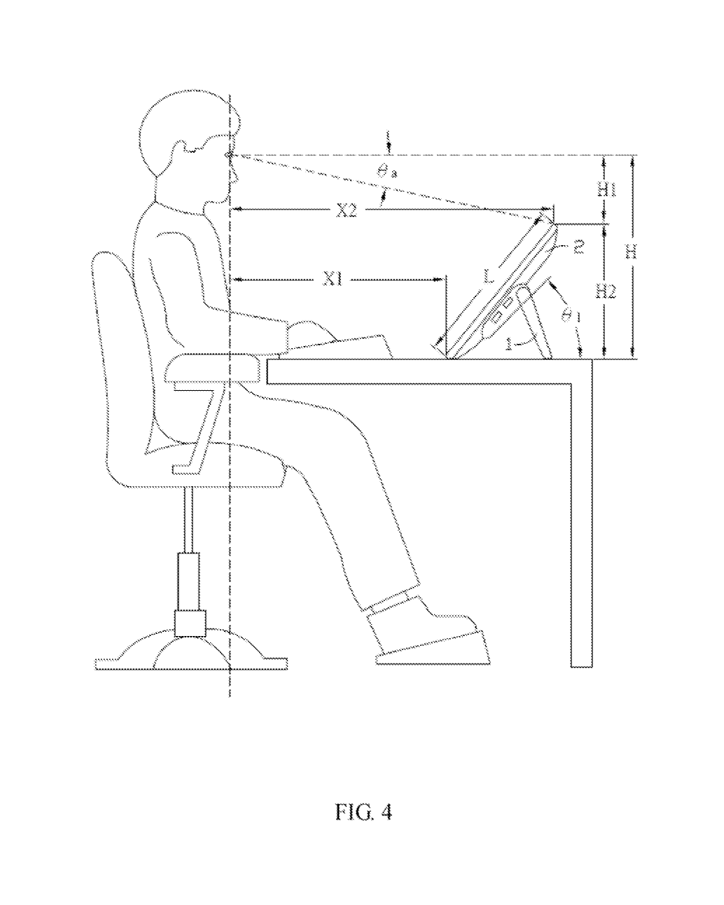

In step S33, the first calculation module 102 calculates a view angle of the user according to the first image and the second image. The view angle is an angle between a horizontal line and a line of sight of the user when the user is looking at the camera 20. As shown in FIG. 4, the angle θₐ is the view angle.

In step S34, the second calculation module 103 calculates a vertical height between the eyeballs of the user and the lower edge of the display 2 according to the view angle, the horizontal distance, and an initial angle between the display 2 and the display bracket 1.

In step S35, when the user is viewing data displayed on the display 2, the second control module 104 obtains a third image of the eyeballs of the user captured by the camera 20.

In step S36, the obtaining module 105 determines a location on the display 2 (e.g., a center of the display 2) where the line of sight of the user looks at by analyzing the third image.

In step S37, the third calculation module 106 calculates an angle to be adjusted between the display 2 and the display bracket 1 according to the vertical height between the eyeballs of the user and the lower edge of the display 2 and the location on the display 2 where the line of sight of the user looks at.

For example, as shown in FIG. 4, the first calculation module 102 calculates the view angle θₐ according to the first image and the second image of the eyeballs of the user when the user is looking at the camera 20. The infrared sensor 21 measures the horizontal distance X1 between the user and the lower edge of the display 2. The initial angle between the display 2 and the display bracket 1 is θ₁. A width value of the display is L. A horizontal distance between the user and the top edge of the display 2 is X2=X1+L*cos θ₁. A vertical height between the eyeballs of the user and the top edge of the display 2 is H1=X2*tan θₐ. A vertical height between the top edge of the display 2 and the lower edge of the display 2 is H2=L*sin θ₁. The vertical height between the eyeballs of the user and the lower edge of the display 2 is H=H1+H2.

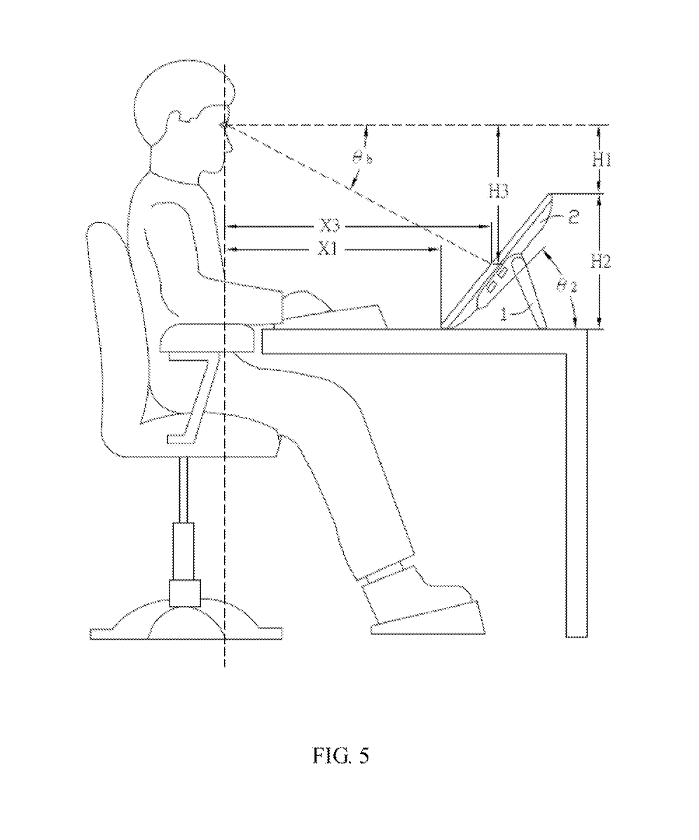

When the user is browsing a webpage displayed on the display 2, the camera 20 captures the third image of the eyeballs of the user. For example, the user is looking at a center position of the display 2, as shown in FIG. 5. The third calculation module 106 calculates a horizontal distance X3 between the user and the center position of the display 2. The horizontal distance is X3=X1+0.5 L*cos θ₁. A vertical distance between the eyeballs of the user and the center position of the display 2 is H3=H1+H2−0.5 L*sin θ₁. A view angle of the user when the user is looking at the center position of the display 2 is θ=tan⁻¹ (H3/X3). The angle between the display 2 and the display bracket 1 needs to be adjusted to θ₂=90−θ_{b}. The angle between the display 2 and the display bracket 1 is adjusted from θ₁ shown in FIG. 4 to θ₂ shown in FIG. 5. The angle θ₂ is comfortable for the user to view the display.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A display bracket, comprising:
a processor; and
a non-transitory computer-readable medium that stores one or more programs, which comprise instructions which when executed by the processor of the electronic device, performs operations of:
(a) prompting a user to look straight ahead and obtaining a first image of eyeballs of the user captured by a camera installed on a display connected to the display bracket, and prompting the user to look at the camera and obtaining a second image of the eyeballs of the user captured by the camera;
(b) controlling an infrared sensor installed in the display to sense a horizontal distance between the user and the display by using infrared rays;
(c) calculating a view angle of the user according to the first image and the second image;
(d) obtaining a third image of the eyeballs of the user captured by the camera when the user is viewing data displayed on the display; and
(e) calculating an angle between the display and the display bracket to be adjusted according to the third image, the horizontal distance between the user and the display, and an initial angle between the display and the display bracket.

2. The display bracket as claimed in claim 1, wherein after operation (c) the operations further comprise:
calculating a vertical height between the eyeballs of the user and the lower edge of the display according to the view angle when the user is looking at the camera, the horizontal distance between the user and the display, and an initial angle between the display and the display bracket.

3. The display bracket as claimed in claim 1, wherein after operation (d) the operations further comprise:
determining a location on the display where the line of sight of the user looks at by analyzing the third image.

4. The display bracket as claimed in claim 1, wherein the horizontal distance between the user and the display is a distance between the user and the lower edge of the display.

5. The display bracket as claimed in claim 1, wherein the view angle is an angle between the horizontal line and a line of sight when the user is looking at the camera.

6. A method being executed by a processor of a display bracket, comprising steps:
(a) prompting a user to look straight ahead and obtaining a first image of eyeballs of the user captured by a camera installed on a display connected to the display bracket, and prompting the user to look at the camera and obtaining a second image of the eyeballs of the user captured by the camera;
(b) controlling an infrared sensor installed in the display to sense a horizontal distance between the user and the display by using infrared rays;
(c) calculating a view angle of the user according to the first image and the second image;
(d) obtaining a third image of the eyeballs of the user captured by the camera when the user is viewing data displayed on the display; and
(e) calculating an angle between the display and the display bracket to be adjusted according to the third image, the horizontal distance between the user and the display, and an initial angle between the display and the display bracket.

7. The method as claimed in claim 6, wherein after step (c) the method further comprises:
calculating a vertical height between the eyeballs of the user and the lower edge of the display according to the view angle when the user is looking the camera, the horizontal distance between the user and the display, and an initial angle between the display and the display bracket.

8. The method as claimed in claim 6, wherein after step (d) the method further comprises:
determining a location on the display where the line of sight of the user looks at by analyzing the third image.

9. The method as claimed in claim 6, wherein the horizontal distance between the user and the display is a distance between the user and the lower edge of the display.

10. The method as claimed in claim 6, wherein the view angle is an angle between the horizontal line and a line of sight when the user is looking at the camera.

11. A non-transitory computer-readable medium having stored thereon instructions that, when executed by a processor of a display bracket, cause the processor to perform operations of:
(a) prompting a user to look straight ahead and obtaining a first image of eyeballs of the user captured by a camera installed on a display connected to the display bracket, and prompting the user to look at the camera and obtaining a second image of the eyeballs of the user captured by the camera;
(b) controlling an infrared sensor installed in the display to sense a horizontal distance between the user and the display by using infrared rays;
(c) calculating a view angle of the user according to the first image and the second image;
(d) obtaining a third image of the eyeballs of the user captured by the camera when the user is viewing data displayed on the display; and
(e) calculating an angle between the display and the display bracket to be adjusted according to the third image, the horizontal distance between the user and the display, and an initial angle between the display and the display bracket.

12. The non-transitory computer-readable medium as claimed in claim 11, wherein after operation (c) the operations further comprise:
calculating a vertical height between the eyeballs of the user and the lower edge of the display according to the view angle when the user is looking the camera, the horizontal distance between the user and the display, and an initial angle between the display and the display bracket.

13. The non-transitory computer-readable medium as claimed in claim 11, wherein after operation (d) the operations further comprise:
determining a location on the display where the line of sight of the user looks at by analyzing the third image.

14. The non-transitory computer-readable medium as claimed in claim 11, wherein the horizontal distance between the user and the display is a distance between the user and the lower edge of the display.

15. The non-transitory computer-readable medium as claimed in claim 11, wherein the view angle is an angle between the horizontal line and a line of sight when the user is looking at the camera.
